(19) United States
(12) Patent Application Publication
(10) Pub. No.: US 2023/0359419 A1
(43) Pub. Date: Nov. 9, 2023

(54) INTELLIGENT HEADS UP DISPLAY

(71) Applicant: TOYOTA MOTOR ENGINEERING & MANUFACTURING NORTH AMERICA, INC., PLANO, TX (US)

(72) Inventors: WILSON-BOON Siang KHOO, Allen, TX (US); Travis Antwan BAILEY, Dallas, TX (US); Ming Michael MENG, Novi, MI (US)

(73) Assignees: TOYOTA MOTOR ENGINEERING & MANUFACTURING NORTH AMERICA, INC., PLANO, TX (US); TOYOTA JIDOSHA KABUSHIKI KAISHA, TOYOTA-SHI (JP)

(21) Appl. No.: 17/740,249

(22) Filed: May 9, 2022

(51) Int. Cl. G06F 3/14; B60K 35/00

(52) U.S. Cl. CPC G06F 3/14; B60K 35/00; B60K 2370/167; B60K 2370/166; B60K 2370/1529; B60K 2370/52

(57) ABSTRACT

Systems and methods are provided for an intelligent HUD. An intelligent HUD may include intelligently enabled display information. Intelligently enabled display information may include vehicle statistics, environmental statistics, warnings, instructions, and other relevant information. Intelligently enabled display information may be displayed on the HUD at a relevant time based on a triggering event. A triggering event may be operation of a vehicle contrary to law, an unsafe driving condition, or a change in information relevant to a driver. Intelligently enabled display information may be turned off after a set period of time, after a driver adjusts vehicle operation in response to a warning or instruction, and/or after a triggering event concludes.

### TECHNICAL FIELD

The present disclosure relates generally to displaying vehicle an driving information, and in particular, some implementations may relate to an intelligent head-up display.

### DESCRIPTION OF RELATED ART

It may be useful for a driver to have access to certain vehicle information and external condition information while driving. For example, a driver may wish to see how much gas is remaining in the tank or a weather alert for icy conditions. Other information may also be useful. This information should be displayed in a location where a driver can see the information without looking away from the road ahead. Current heads up display systems display desired information in a viewable location while driving.

Existing heads up display systems can cause problems, however, because they include a large amount of information in the display. A large amount of information can overwhelm drivers. Large amounts of display information can result in driver distraction, increasing the risk of accidents. Additionally, displaying large or voluminous amounts of information may make it difficult for a driver to quickly locate and understand the information the driver most needs or is most interested in seeing.

In fact, much of the information displayed by current systems is not needed by the driver at all. Additionally, much of the information displayed by current systems is only needed for a temporary period of time. Further, individual drivers may have differing preferences regarding which information they would like to see while driving/while in a vehicle. Many drivers choose to turn off heads up display information because the large amount of information presented is too distracting, and because most of the displayed information is not relevant. Additionally, even drivers who might need or be interested in some information may still choose to turn off the display because the overwhelming amount of information conceals useful information, making the display too difficult to use.

### BRIEF SUMMARY OF THE DISCLOSURE

According to various embodiments of the disclosed technology an intelligent heads up display (“HUD”) system may include a HUD. It may also include vehicle sensors and systems. It may also include an intelligent HUD circuit. The circuit may receive vehicle sensor and system data. The circuit may determine whether the sensor and system data indicate a triggering event. Based on its determination that the sensor and system data indicate a triggering event, the circuit may instruct the HUD to selectively display intelligently enabled display information relevant to the triggering event.

In an embodiment, the triggering event may comprise vehicle operation contrary to law. In another embodiment, the triggering event may comprise a dangerous driving condition. In another embodiment, the triggering event may comprise detection of a dangerous weather condition. In another embodiment, the triggering event may comprise a composite event based on both detection of a dangerous weather condition and detection of a nearby road condition rendered more dangerous by the dangerous weather condition. In another embodiment, the dangerous weather condition may comprise icy conditions and the nearby road condition rendered more dangerous by the icy conditions may comprise a bridge over which the vehicle is expected to travel. In another embodiment, the dangerous driving condition comprises detection of a collision risk between a vehicle equipped with the intelligent HUD system and a preceding obstacle.

In another embodiment, the triggering event may comprise an informational change. For example, the informational change may be a change in navigation instructions. In another example, the information change may be an incoming call. In another example, the informational change may be a change in a music track played by a vehicle equipped with the intelligent HUD system. In another example, the informational change may include activation of an anti-lock braking system (“ABS”).

In an embodiment of an intelligent HUD system, the intelligent HUD circuit may instruct the HUD to display the current vehicle speed. In another embodiment, the intelligent HUD circuit may instruct to HUD to display a speed limit set for an area in which the driver is operating the vehicle. In another embodiment, the triggering event may include detection of a driver operating a vehicle at a speed exceeding a speed limit set for an area in which the driver is operating the vehicle.

In another embodiment of an intelligent HUD system, the intelligent HUD circuit may further receive updated vehicle sensor and system data, determine whether the sensor and system data indicate a triggering event, and based on its determination that the sensor and system data no longer indicate a triggering event, instruct the HUD to turn off intelligently enabled display information relevant to the triggering event. In an embodiment, the intelligent HUD circuit may instruct the HUD to selectively turn off intelligently enabled display information relevant to the no longer detected triggering event, without turning off the entire display. In another embodiment, the intelligent HUD circuit may further instruct the HUD to continue to selectively display the intelligently enabled display information for a set period of time following the triggering event and instruct the HUD to selectively turn off the display of the intelligently enabled display information after the set period of time elapses.

A customizable intelligent heads up display (“HUD”) system may include a HUD, vehicle sensors and systems, a user interface for a user to customize intelligently enabled display information for display on the HUD based on customized triggering events, and an intelligent HUD circuit. The circuit may receive a user indication of intelligently enabled display information based on customized triggering events form the user interface, receive vehicle sensor and system data, determine whether the sensor and system data indicate a customized triggering event, and based on its determination that the sensor and system data indicate a customized triggering event, instruct the HUD to selectively display the user indicated intelligently enabled display information relevant to the customized triggering event.

In an embodiment of a customizable intelligent HUD system, the intelligent HUD circuit may further, receive a user indication of a customized period of time during which the user would like the HUD to display the intelligently enabled display information indicated by the user, instruct the HUD to continue to display user indicated intelligently enabled display information for the customized period of time set by the user, and instruct the HUD to turn off the user indicated intelligently enabled display information after the customized period of time by the user expires.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example architecture for detecting conditions associated with intelligent heads up display in accordance with one embodiment of the systems and methods described herein.

FIG. 3 is a diagram showing an example of information that may or may not be displayed on an intelligent HUD.

FIG. 4 is a flow diagram showing an example of a method for intelligent display of information on a HUD.

FIG. 5 is an example computing component that may be used to implement various features of embodiments described in the present disclosure.

The figures are not exhaustive and do not limit the present disclosure to the precise form disclosed.

### DETAILED DESCRIPTION

Embodiments of the systems and methods disclosed herein can provide an intelligent heads up display (“HUD”) that shows information based on necessity, and/or a driver's preference. Information may also be displayed for only a limited, relevant time period, preventing a static, crowded display that could distract the driver from being present. A HUD may include information about a vehicle and external conditions to (typically) a driver (although a HUD may be used to present to other vehicle occupants/users. This information may include vehicle speed, vehicle location, navigation directions, music information, weather information, traffic reports, fuel and/or battery status, and other relevant information.

In an embodiment, a selected piece of information may be displayed on the HUD in response to a triggering event. A vehicle may be equipped with sensors and other data to detect a triggering event. In an embodiment, sensors may detect both when a triggering event has occurred and when a triggering event or condition is not present. For example, selected pieces of information may include vehicle speed and navigation information such as the distance to an upcoming maneuver. Selected pieces of information may also include music information such as a track change or a new song playing and weather information, such as icy conditions. Selected pieces of information may also include environmental conditions, such as an upcoming bridge, narrow road, or sharp bend in the road, and traffic information, such as an upcoming accident, and other relevant information.

A composite warning or composite information may also be displayed. A composite warning or composite information may be a warning or information display based on two or more factors. For example, conditions may be icy and a bridge may be ahead. Due to these two factors, an instruction to drive cautiously or an indication of icy conditions may be displayed.

In an embodiment, selected or indicated information may be displayed on the HUD for certain periods of time. In some embodiments, information may be displayed on the HUD for a period of time based on the triggering event. For example, information may be displayed during a triggering event, such as while a driver is exceeding the speed limit, and turned off when the triggering event ends or passes, such as when the driver slows down below the speed limit In some embodiments, information may be displayed for a set, selected period of time. For example, information be displayed only for 3 seconds following a triggering event. In an embodiment, a driver may be able to set and/or customize the period of display time. In an embodiment, display information may automatically turn off after the absence of a triggering event is detected.

In an embodiment, a driver may customize what information is displayed on the HUD. A driver may choose to turn off information that the driver does not wish to see. A driver may turn on information that the driver prefers to see or needs to see. For example, a driver that does not listen to music in the vehicle may choose to turn off all music related information on the HUD. A driver may choose to leave on information related to safety alerts, however. Additionally, an intelligent HUD system may include default or recommended settings. For example, the intelligent HUD system may recommend that drivers turn on or enable safety related warnings, such as warnings about dangerous weather or impending collisions. Other information may, as a default setting, be turned off. A driver may then enable only the non-safety information the driver wishes to see.

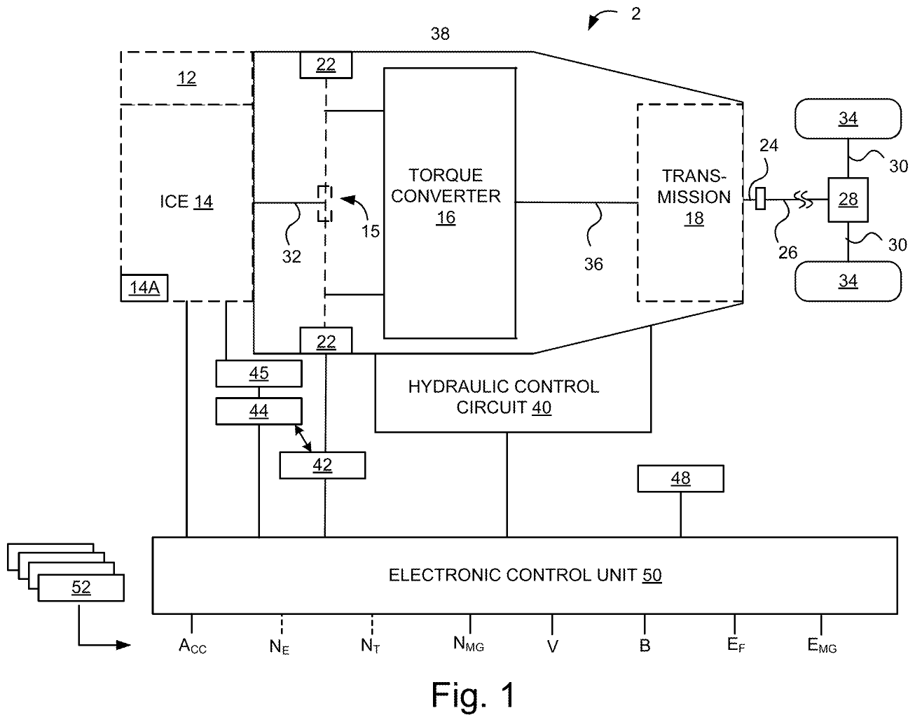

The systems and methods disclosed herein may be implemented with any of a number of different vehicles and vehicle types. For example, the systems and methods disclosed herein may be used with automobiles, trucks, recreational vehicles and other like on- or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for an intelligent heads up display can be implemented in other types of vehicle including gasoline- or diesel-powered vehicles, fuel-cell vehicles, electric vehicles, or other vehicles.

FIG. 1 illustrates a drive system of a vehicle 102 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 102 relies on the motive force generated at least by internal combustion engine 14, and a clutch 15 may be included to engage engine 14. In the EV travel mode, vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 2 and is powered electrically via a battery 44. Battery 44 may be implemented as one or more batteries or other power storage devices including, for example, lead-acid batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 102 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in vehicle 102. For example, electronic control unit 50 may receive signals that indicate vehicle operating conditions or characteristics, or signals that can be used to derive vehicle operating conditions or characteristics. These may include, but are not limited to accelerator operation amount, A_{CC}, a revolution speed, N_{E}, of internal combustion engine 14 (engine RPM), a rotational speed, N_{MG}, of the motor 22 (motor rotational speed), and vehicle speed, N_{V}. These may also include torque converter 16 output, N_{T} (e.g., output amps indicative of motor output), brake operation amount/pressure, B, battery SOC (i.e., the charged amount for battery 44 detected by an SOC sensor). Accordingly, vehicle 102 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, E_{F}, motor efficiency, E_{MG}, hybrid (internal combustion engine 14+MG 12) efficiency, acceleration, A_{CC}, etc. Sensors 52 may also include camera, LIDAR, and other sensor types configured to detected environmental conditions external to a vehicle. For instance, camera sensors may be configured to detected an obstacle in the path of the vehicle.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

FIG. 1 is provided for illustration purposes only as an example of a vehicle system with which embodiments of the disclosed technology may be implemented. One of ordinary skill in the art reading this description will understand how the disclosed embodiments can be implemented with various different vehicle platforms.

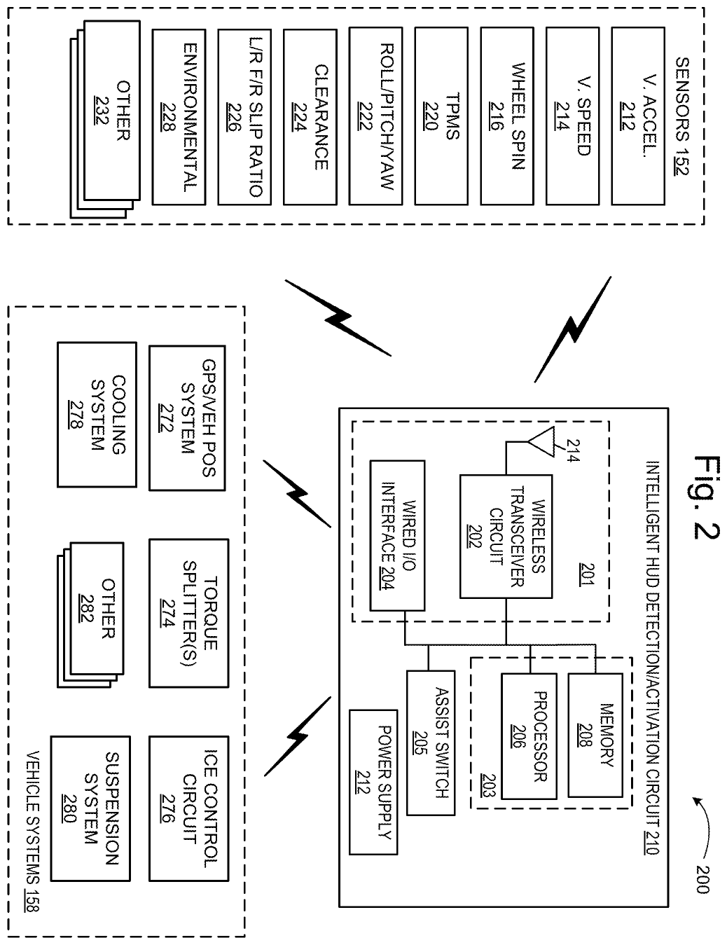

FIG. 2 illustrates an example architecture for activating an intelligent HUD in accordance with one embodiment of the systems and methods described herein. Referring now to FIG. 2, in this example, intelligent HUD activation system 200 includes an intelligent HUD activation/deactivation circuit 210, a plurality of sensors 152, and a plurality of vehicle systems 158. Sensors 152 and vehicle systems 158 can communicate with intelligent HUD activation/deactivation circuit 210 via a wired or wireless communication interface. Although sensors 152 and vehicle systems 158 are depicted as communicating with intelligent HUD activation/deactivation circuit 210, they can also communicate with each other as well as with other vehicle systems. Intelligent HUD activation/deactivation circuit 210 can be implemented as an ECU or as part of an ECU such as, for example electronic control unit 50. In other embodiments, intelligent HUD activation/deactivation circuit 210 can be implemented independently of the ECU.

Intelligent HUD activation/deactivation circuit 210 in this example includes a communication circuit 201, a decision circuit (including a processor 206 and memory 208 in this example) and a power supply 212. Components of intelligent HUD activation/deactivation circuit 210 are illustrated as communicating with each other via a data bus, although other communication in interfaces can be included. Intelligent HUD activation/deactivation circuit 210 in this example also includes a manual assist switch 205 that can be operated by the user to manually select the assist mode.

Processor 206 can include a GPU, CPU, microprocessor, or any other suitable processing system. The memory 208 may include one or more various forms of memory or data storage (e.g., flash, RAM, etc.) that may be used to store the calibration parameters, images (analysis or historic), point parameters, instructions and variables for processor 206 as well as any other suitable information. Memory 208, can be made up of one or more modules of one or more different types of memory, and may be configured to store data and other information as well as operational instructions that may be used by the processor 206 to intelligent HUD activation/deactivation circuit 210.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up a intelligent HUD activation/deactivation circuit 210.

Communication circuit 201 either or both a wireless transceiver circuit 202 with an associated antenna 214 and a wired I/O interface 204 with an associated hardwired data port (not illustrated). As this example illustrates, communications with intelligent HUD activation/deactivation circuit 210 can include either or both wired and wireless communications circuits 201. Wireless transceiver circuit 202 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 214 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by intelligent HUD activation/deactivation circuit 210 to/from other entities such as sensors 152 and vehicle systems 158.

Wired I/O interface 204 can include a transmitter and a receiver (not shown) for hardwired communications with other devices. For example, wired I/O interface 204 can provide a hardwired interface to other components, including sensors 152 and vehicle systems 158. Wired I/O interface 204 can communicate with other devices using Ethernet or any of a number of other wired communication protocols whether standardized, proprietary, open, point-to-point, networked or otherwise.

Power supply 212 can include one or more of a battery or batteries (such as, e.g., Li-ion, Li-Polymer, NiMH, NiCd, NiZn, and NiH₂, to name a few, whether rechargeable or primary batteries), a power connector (e.g., to connect to vehicle supplied power, etc.), an energy harvester (e.g., solar cells, piezoelectric system, etc.), or it can include any other suitable power supply.

Sensors 152 can include, for example, sensors 52 such as those described above with reference to the example of FIG. 1. Sensors 52 can include additional sensors that may or not otherwise be included on a standard vehicle 10 with which the intelligent HUD activation system 200 is implemented. In the illustrated example, sensors 152 include vehicle acceleration sensors 212, vehicle speed sensors 214, and wheelspin sensors 216 (e.g., one for each wheel). As shown, sensors 152 also include a tire pressure monitoring system (TPMS) 220 and accelerometers such as a 3-axis accelerometer 222 to detect roll, pitch and yaw of the vehicle. Sensors 152 also include vehicle clearance sensors 224, left-right and front-rear slip ratio sensors 226, and environmental sensors 228 (e.g., to detect salinity or other environmental conditions). Additional sensors 232 can also be included as may be appropriate for a given implementation of intelligent HUD activation system 200. For example, sensors 152 may also include sonar, lidar, and/or camera sensors configured to detected external vehicle conditions, such as, for example, an obstacle in the presence of the vehicle.

Vehicle systems 158 can include any of a number of different vehicle components or subsystems used to control or monitor various aspects of the vehicle and its performance. In this example, the vehicle systems 158 include a GPS or other vehicle positioning system 272; torque splitters 274 they can control distribution of power among the vehicle wheels such as, for example, by controlling front/rear and left/right torque split; engine control circuits 276 to control the operation of engine (e.g. Internal combustion engine 14); cooling systems 278 to provide cooling for the motors, power electronics, the engine, or other vehicle systems; suspension system 280 such as, for example, an adjustable-height air suspension system, and other vehicle systems.

During operation, intelligent HUD activation/deactivation circuit 210 can receive information from various vehicle sensors to determine whether an intelligent HUD should be activated. Also, the driver may manually activate an intelligent HUD by operating assist switch 205. Communication circuit 201 can be used to transmit and receive information between intelligent HUD activation/deactivation circuit 210 and sensors 152, and intelligent HUD activation/deactivation circuit 210 and vehicle systems 158. Also, sensors 152 may communicate with vehicle systems 158 directly or indirectly (e.g., via communication circuit 201 or otherwise).

In various embodiments, communication circuit 201 can be configured to receive data and other information from sensors 152 that is used in determining whether to activate the intelligent HUD. Additionally, communication circuit 201 can be used to send an activation signal or other activation information to various vehicle systems 158 as part of entering the intelligent HUD mode. For example, as described in more detail below, communication circuit 201 can be used to send signals to, for example, one or more of: torque splitters 274 to control front/rear torque split and left/right torque split; motor controllers 276 to, for example, control motor torque, motor speed of the various motors in the system; ICE control circuit 276 to, for example, control power to engine 14 (e.g., to shut down the engine so all power goes to the rear motors, to ensure the engine is running to charge the batteries or allow more power to flow to the motors); cooling system (e.g., 278 to increase cooling system flow for one or more motors and their associated electronics); suspension system 280 (e.g., to increase ground clearance such as by increasing the ride height using the air suspension). The decision regarding what action to take via these various vehicle systems 158 can be made based on the information detected by sensors 152. Examples of this are described in more detail below.

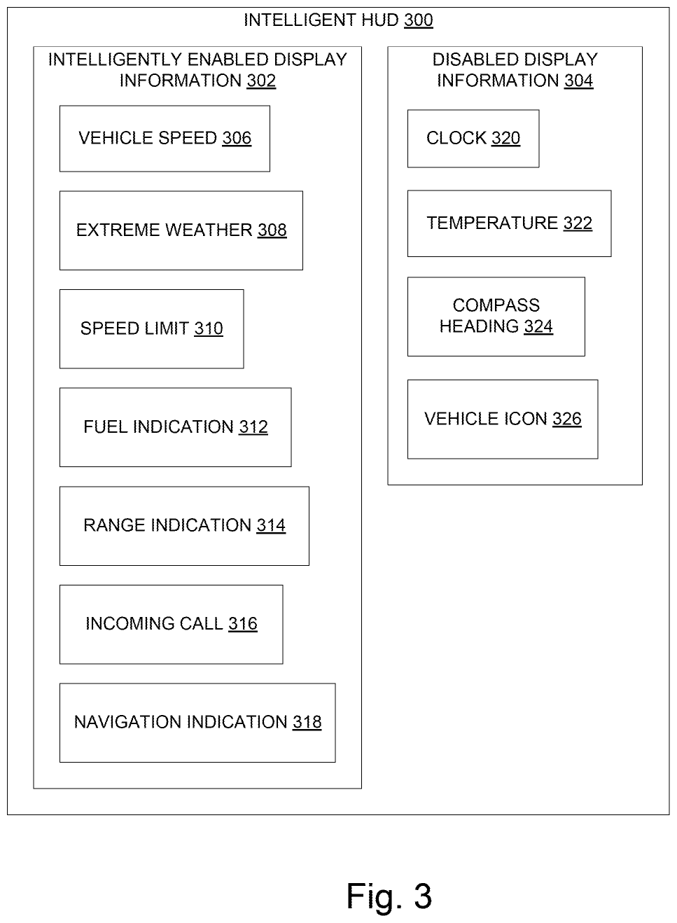

FIG. 3 is a diagram showing an example of information that may or may not be displayed on an intelligent HUD 300. FIG. 3 may be representative of an example options and/or selective menu for the system. In an embodiment, a user may use a menu, such as the example shown in FIG. 3, to customize an intelligent HUD display. An intelligent HUD 300 may include intelligently enabled display information 302. Intelligently enabled display information 302 may include information that may be useful to a driver at a specific time and/or under a specific circumstance. Intelligently enabled display information 302 may be displayed only for a selected time at which or during which the intelligently enabled display information 302 is relevant and/or useful to a driver. Intelligently enabled display information 302 may present, e.g., event-relevant information or triggered information in a non-perpetual/permanent manner. not be constantly and/or permanently displayed.

Intelligently enabled display information 302 may be displayed in response to a triggering event. In an embodiment, the triggering event may be detected by vehicle sensors. In an embodiment, the triggering event may be detected based on data received by the vehicle indicating the triggering event. In an embodiment, a triggering event may be detected and/or confirmed based on both vehicle sensor information and external data. In another embodiment, a driver may customize an intelligent HUD 300. The driver may select, in advance, which information may comprise the intelligently enabled display information 302.

Intelligently enabled display information 302 may be turned off when it is no longer useful and/or relevant to a driver. For example, in an embodiment, a triggering event may end or pass. If a triggering event ends or passes, intelligently enabled display information 302 related to the triggering event may no longer be relevant. In an embodiment, vehicle sensors and/or external data may detect and/or confirm that a triggering event has passed or is no longer present. Based on the sensor information and/or data, the intelligently enabled display information 302 related to the triggering event may be turned off. In an embodiment, intelligently enabled display information 302 may also be turned off after a set period of time elapses. For example, intelligently enabled display information 302 may be turned off after a three second period following detection and/or confirmation of the triggering event.

In an embodiment, intelligently enabled display information may include vehicle speed 306. In an embodiment, intelligently enabled display information may include speed limit 310. Vehicle speed 306 may be displayed for a period of time during which vehicle speed 306 is relevant or useful to a driver. For example a driver may be driving a vehicle at a speed limit set for the area of the road in which the driver is driving. The driver may continue into a geographic area in which the set speed limit is lower than the speed limit in the area immediately prior. The driver may still be driving the speed limit at the higher speed and thus may be exceeding the speed limit. An intelligent HUD system may include vehicle sensors to detect vehicle speed. The system may also include data, such as speed limit data for areas of road. The intelligent HUD system may, using the sensors and data, determine that a driver is exceeding the speed limit. A driver exceeding the speed limit may be a triggering event. Immediately upon detecting that a driver is exceeding the speed limit, an intelligent HUD system may display a warning to the driver using the HUD. The warning may include the driver's current speed 306. The warning may also include the speed limit 310 for the area in which the driver is driving. These pieces of information, the warning, driver's speed, and/or speed limit may not be displayed using the HUD unless the triggering event, the driver exceeding the speed limit, is detected.

The driver may, in response to the warning or for some other reason, reduce their speed below the speed limit. The intelligent HUD system may, using the vehicle sensors, detect the reduction in speed. The intelligent HUD system may check the speed against speed limit data. Based on its check, the intelligent HUD system may determine that a driver is no longer exceeding the speed limit. If the intelligent HUD system has determined that a driver is no longer exceeding the speed limit, the intelligent HUD system may turn off the warning, displayed current speed 306, and/or displayed speed limit 310 as these pieces of information may no longer be of immediate relevance to the driver.

In an embodiment, intelligently enabled display information may include a fuel indication 312 and/or a range indication 314. Fuel information may be relevant to a driver of a gas-powered vehicle. Fuel information may include an indication of remaining miles. Fuel information may also include the fuel level. Fuel information may also include information about nearby gas stations and/or a vehicle's proximity to nearby gas stations. Range information may be relevant to a driver of an electric vehicle. Range information may include an indication of remaining miles. Range information may also include a battery charge level. Range information may also include information about nearby charging stations and/or a vehicle's proximity to nearby charging stations. Both fuel and range information may be relevant to a driver of a hybrid vehicle. Fuel and/or range information may be displayed for a period of time during which fuel and/or range information is intelligent to a driver. For example, a the fuel level and/or battery charge level of a vehicle may be running low. Low may mean that a driver may be able to drive less than about 30 to 50 miles before running out of fuel and/or charge. In another example, fuel and/or range information may be relevant to a driver at the start of a journey, when a driver turns on the vehicle. Fuel and/or range information may also be relevant to a driver at the end of a journey, when a driver puts the vehicle into park or pulls the vehicle into a garage. Fuel and/or range information may also be relevant to a driver in conjunction with navigation information. For example, a driver may request navigation instructions to a destination. The destination may be a distance of X miles from the driver's current location. The vehicle may not have sufficient fuel or range to travel the full X miles. Therefore, in this situation, fuel and/or range information may be relevant to the driver at the beginning of the driver's journey, once the driver has input their destination. This information may alert a driver that they will, at some point, need to fuel or charge their vehicle to complete their journey.

A vehicle may be equipped with sensors to detect fuel level and/or battery level. A vehicle may also be equipped with sensors, such as GPS, to determine the vehicle's location. A vehicle may also leverage environmental data, such as the presence of nearby fueling or charging stations. An intelligent HUD system may leverage sensor information and data to determine when a display of information related to fuel and/or range may be relevant to a driver. For example, an intelligent HUD system may determine that a vehicle is at or below a fuel or charge threshold, indicating that a driver should fuel or charge their vehicle to avoid becoming stuck. For example, an intelligent HUD system may determine that a driver may travel only an additional 30 miles using the vehicle's current fuel level and/or state of charge. In another example, an intelligent HUD system may determine that a vehicle is approaching a stretch of road lacking fueling and/or charging stations. For example, an intelligent HUD system may determine that a vehicle is close to a fueling or/charging station but that the next fueling and/or charging station along the vehicle's planned course is a long distance away. The intelligent HUD system may then display information directing the driver to fuel or charge the vehicle at the upcoming gas station or charging station to avoid becoming stuck. In this situation, the vehicle may not have a low fuel or charge level. In other words, the vehicle may be able to travel a distance greater than 30 to 50 miles using the current fuel or charge level. However, the next charging or fueling station may still be too far away for the vehicle to reach using its current fuel and/or charge level.

In an embodiment, the systems and methods disclosed herein may be implemented in a battery electric vehicle (“BEV”). For a BEV, intelligently enabled display information may include a range indication 314 for battery range. Range information may include an indication of remaining miles. Range information may also include a battery charge level. Range information may also include information about nearby charging stations and/or a vehicle's proximity to nearby charging stations. Range information may also include information about environmental conditions affecting available range.

A BEV may be equipped with sensors to detect a battery charge level and/or range available based on battery charge. A BEV may also be equipped with sensors, such as GPS, to determine the vehicle's location, as well as environmental sensors, such as a temperature sensor, to determine conditions external to a vehicle. An intelligent HUD system may leverage sensor information and data to determine when a display of information related to range may be relevant to a driver. For example, an intelligent HUD system may determine that the current available battery range is too low for a vehicle to reach its destination. This detection may be performed by leveraging sensors detecting level or charge as well as sensors, such as GPS sensors, detecting a BEV's location relative to its destination. In response to a determination that the range is too low for the BEV to make it to the destination, a range indication may be displayed on the HUD. The range indication may inform the driver about how many miles/how much driving time is left until the BEV runs out of charge. The range information may also alert the driver to nearby charging stations. In another embodiment, environmental conditions may affect available range. For example, range may be reduced due to cold temperatures. The BEV may be equipped with sensors to detect the battery charge level as well as sensors, such as temperature sensors, to detect environmental conditions. In response to a determination that temperatures are cold enough to reduce range, a range indication may be displayed on the HUD. The range indication may, for example, include a warning alerting a driver to the range reduction.

In an embodiment, fuel and/or charge information may be turned off after a set period of time. In another embodiment, fuel/and or charge information may be turned off after the triggering event has based or is no longer present. For example, fuel and/or charge information may be turned off after a driver has fueled or charged their vehicle. In another example, fuel and/or charged information may be turned off when a driver takes an appropriate action to mitigate a triggering event. For example, fuel and/or charge information may be turned off once a driver begins its journey toward a nearby fueling or charging station, as directed by the intelligent HUD system.

In an embodiment, intelligently enabled display information 302 may include extreme weather information 308. Extreme weather information may include indications of weather that may pose a risk to a driver. For example, extreme weather information may include information about flood conditions, icy conditions, extreme heat, weather causing poor visibility, such as snow and fog, and other relevant weather conditions. A vehicle may include sensors that may detect an extreme weather condition. For example, a vehicle may include a temperature sensor. A temperature sensor may detect an external temperature comprising an extreme weather condition. For example, an externally detected temperature may be below freezing which may indicate icy conditions. If icy conditions are detected, a warning may be displayed to a driver to exercise caution using the intelligent HUD. A temperature sensor may also detect extreme heat. Information displayed to a driver may include temperature information, a type of weather condition, e.g., snow or flood, and/or a warning to a driver to exercise caution.

In an embodiment, intelligently displayed information may include a composite warning. The composite warning may be based both on detected extreme weather as well as other relevant circumstances. For example temperature sensors may detect that conditions are icy. Environmental data and/or sensors may also determine that a driver is approaching a dangerous part of the road. For example, a bridge may be ahead or a sharp turn. The extreme weather information may become especially relevant to a driver given that a dangerous part of the road is upcoming. For example, if conditions are icy and a bridge is ahead, a driver may need to exercise special caution to stay safe. In this case, a composite warning, taking into account both the detected temperature and the upcoming dangerous part of the road, may be displayed to the driver using the intelligent HUD system. For example, the system may instruct a driver to slow down.

In an embodiment, a driver may customize the intelligent HUD system to display extreme weather information at relevant times. For example, a driver may have young children or pets. A driver may leave their child and/or pets in the car for short periods of time. A driver may configure an intelligent HUD system to display a warning if a temperature is too high to leave a child or pet in the car. The warning may displayed, for example, when a driver puts the vehicle into park.

In an embodiment, intelligently enabled display information may also include a navigation indication 318. A navigation indication may include instructions to a driver to take a certain action in order to guide a vehicle to a desired destination. Vehicle sensors and/or external data may show a current vehicle position. For example GPS data, a pre-generated map, and or camera sensors may all indicate a vehicle location or vehicle path along a certain trajectory. Navigation instructions may only be relevant for a short period of time. For example, navigation instructions may instruct a driver to make a turn or merge onto the freeway. Navigation instructions may include the desired maneuver, e.g., a turn or merge, and/or a threshold distance until the maneuver is set to occur, e.g., take exit 4B in 0.5 miles.

These instructions are only relevant to a driver slightly before the anticipated maneuver needs to happen. Therefore, the navigation indication may be displayed for a few seconds during a time period in which a driver may be preparing to make a maneuver. The instruction is no longer relevant after a few seconds have passed and a driver has absorbed the instruction. The instruction may also no longer be relevant after a driver has completed the maneuver. Therefore, the instruction may be turned off after a few seconds have passed and/or after a driver has completed the maneuver. Additionally, navigation instructions may only be relevant when there is a change in trajectory. For example, navigation instructions may not be relevant to a driver if a driver is continuing on a given stretch of road for several miles. Therefore, navigation instructions may be displayed intelligently only when there is a change in instructions and/or trajectory.

In an embodiment, other types of intelligently enabled display information 302 may also be displayed. For example, incoming call information 316 may be displayed while a call is incoming. This information may include the name of the caller and/or the number the caller is dialing from. This information may only be relevant for a short period of time. This information may also only be relevant until a driver has made a decision regarding the call. Therefore, in an embodiment, incoming call information may be shown for a few seconds following an incoming call and then turned off. In another embodiment, incoming call information may be displayed while a call is incoming and until a driver has made a decision regarding the call. For example, the information may be turned off once the driver has accepted or declined the call.

Other types of intelligently enabled display information may also be included. For example, music information such as the name of an artist, track, or album, may be displayed only when there is a change in track. The information may be displayed for a period of a few seconds and then turned off. In another example, a warning may be relevant to a driver in a certain situation. For example is ABS is triggered, a vehicle may be at risk of slipping if the brakes come on. Therefore, a warning may instruct a driver to slow down or exercise caution in applying the brakes to avoid slipping. The information may be turned off after a period of a few seconds or once a driver has slowed down.

In another embodiment, an alert instructing a driver to slow down may be based on an obstacle. For example, vehicle sensors and data may determine that a driver is within a threshold distance of a preceding vehicle and at risk of collision. Therefore, an instruction to the driver to slow down may be displayed to a driver once the driver passes within the threshold distance. In another embodiment, sensors and data may confirm that the rate of change in the distance between the vehicle and a preceding vehicle and/or obstacle exceeds a threshold distance, putting the driver at risk of a collision. A warning may also be displayed in this situation. The warning may be turned off after a few seconds or once the threshold distance becomes safe again.

In an example embodiment of the systems and methods disclosed herein, intelligently enabled display information may also be configured using an artificial intelligent (“AI”) based customization. For example, a particular driver may be prone to excessive speed. Vehicle sensors and data may confirm the driver speeds frequently. AI-based customization may the enable speed warnings. AI-based customization may also include a fine-tuning of when intelligently enabled display information is displayed. For example, a driver using navigation in conjunction with an intelligent HUD system may be prone to missing instructions if the instructions are displayed at a distance of less than 0.5 miles before a maneuver. Therefore, using AI customization, warnings may be displayed at a greater threshold distance to ensure the particular driver has sufficient warning to complete the maneuver. Many other possibilities for AI-based customization exist. The foregoing examples are not intended to limit this embodiment.

An intelligent HUD system may also include categories of disabled display information 304. Disabled display information 304 may include information that is not displayed on a HUD while a driver is driving because it is not likely to be useful or relevant to a driver. Disabled display information 304 may include, for example a clock 320. While it may be generally desirable for a driver to know the time, knowing what time it is does not facilitate safer, better, or more efficient driving. Therefore, a clock 320 may not be included in an intelligent HUD 300. Disabled display information 304 may also include temperature 322. While extreme weather 308, discussed above, may be relevant, having a constant display of the temperature outside of a vehicle likely does not facilitate safer, better, or more efficient driving. Disabled display information 304 may also include a compass heading 324. While a compass heading 324 may be useful in certain situations, a driver may not need a constant display of a compass heading while driving. For instance, a driver familiar with an area may already know what direction they are heading. In another example, a driver may not know what direction they are heading in but may rely on navigation indications 318, discussed above. A compass heading 324 is likely not needed in either of these situations. Disabled display information 304 may also include a vehicle icon 326 or other information, whether text or picture based, that does not convey any immediately useful or relevant information to a driver.

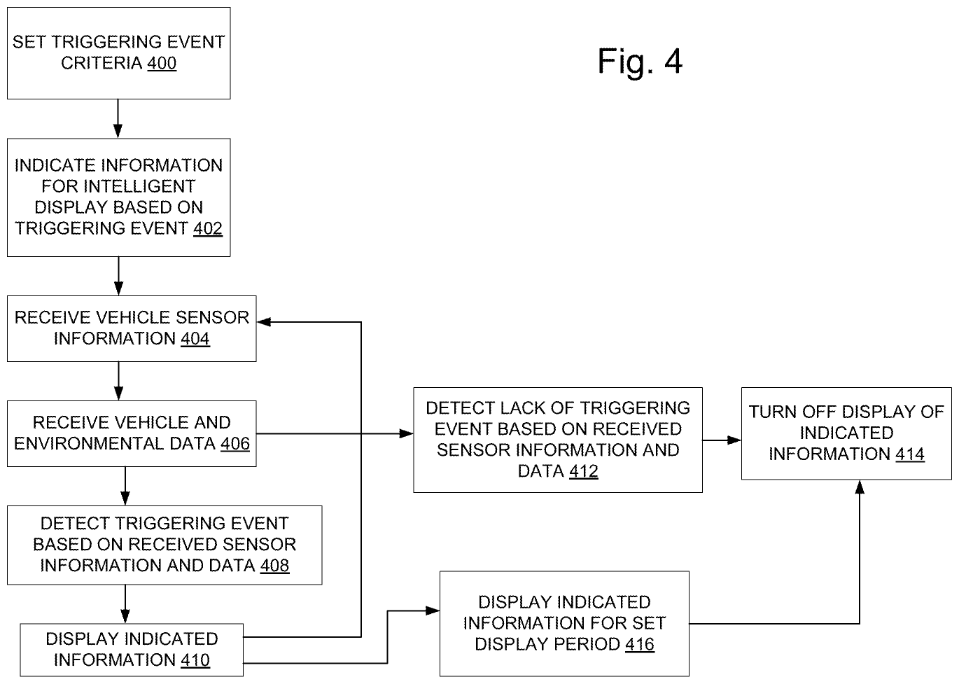

FIG. 4 is a flow diagram showing an example of a method for intelligent display of information on a HUD. As a first operation 400, a user or administrator may set triggering event criteria. In other words, a user or administrator may decide upon a set of triggering events that warrant display of information using an intelligent HUD. A user or administrator may determine which conditions constitute a triggering event. For example, as discussed above, an administrator may determine that vehicle speed 306 should be displayed if a driver is exceeding the speed limit. A triggering event may then be that a driver is exceeding the speed limit. Criteria for the triggering event may include determining vehicle speed, determining the speed limit in the driving region, and determining that the vehicle is driving faster than the speed limit.

In an embodiment, a user may set triggering event criteria. For example, a user may struggle with speeding and may choose to customize the intelligent HUD to display a warning if the user exceeds the speed limit. In an embodiment, an administrator may set the triggering event criteria. An administrator may be, for example, a car manufacturer. The administrator may set default triggering event criteria for situations in which many drivers could benefit for an intelligent display. For example, because many drivers speed, an administrator may set a driver exceeding the speed limit as a triggering event.

As a second operation 402, a user or administrator may indicate information for intelligent display based on a triggering event. For example, as discussed above, a user or administrator may choose to display vehicle speed if a user is exceeding the speed limit. In an embodiment, a user or administrator may choose to display the speed limit if the driving is speeding. In an embodiment, both the speed limit and vehicle speed may be displayed. FIG. 3 provides other examples of the types of information that may be intelligently displayed based on a triggering event. FIG. 3 is not intended to be exclusive, however. Other types of information that may be relevant or useful to drivers may also be displayed.

As a third operation 404, an intelligent HUD system may receive vehicle sensor information. For example, an intelligent HUD system may receive information from a camera sensor. A camera sensor may detect an obstacle in the road and/or a preceding vehicle in close proximity to the vehicle. Sensor information may also be received from other types of sensors. For example, sensor information may include a vehicle speed. Sensor information may also include whether an anti-lock braking system (“ABS”) is triggered. As a fourth operation 406, which may occur concurrently with the third operation 404, an intelligent HUD system may receive vehicle and environmental data. For example, a vehicle may receive information related to extreme weather conditions in the area in which the vehicle is driving. For example, environmental data may include data indicated a road region is icy. Environmental data may also include GPS data. Environmental data may also include traffic data. The fourth operation 406 may be performed in addition to or instead of the third operation 404. Alternatively, the third operation 404 may be performed instead of the fourth operation 406.

As a fifth operation 408, an intelligent HUD system may detect a triggering event based on the received sensor information and/or data. For example, as discussed above, a vehicle exceeding the speed limit may be one example of a triggering event. Sensor information may indicate that a vehicle is traveling at a certain speed. Environmental data may include an indication of the speed limit of a road area. Environmental data may also confirm that a vehicle is traveling in a road region with a specific speed limit. A comparison of the sensor data and environmental data may indicate that a vehicle is exceeding the speed limit set for the area in which the vehicle is traveling. This condition may constitute a triggering event.

As a sixth operation 410, the intelligent HUD system may display indicated information. For example, the system may display information relevant to the triggering event. The information may include vehicle statistics and information, such as speed, whether ABS is enabled, information about music, information about incoming calls, range and fuel level information, and other vehicle information. Information may also include environmental information such as weather, and traffic information. In an embodiment, information may include navigation indications. Information may also include a warning or message to a driver based on a triggering event. For example, the information may include a text-based warning instructing a driver to reduce speed if a driver is exceeding the speed limit.

In an embodiment, the displayed information of operation six 410 may be displayed for a set period as a seventh operation 416. For example, the displayed information may be displayed for a period of one to ten seconds. In an example embodiment, the information may be displayed for a period of three seconds. Displaying the information for a period of one to ten seconds may be sufficient to alert a driver to relevant information. A driver may not need a persistent display of information if the information is likely to only be relevant for a short period or snapshot in time. For example, if a driver receives an incoming call while driving, information about the incoming call may only be relevant for a short period of time because the driver, within a short period of time, may form a decision about whether or not to accept the call.

In an embodiment, after the seventh operation 416, in which the display of indicated information persists for a set display period, the intelligent HUD system may be configured to turn off the indicated display information as an eighth operation 414. The intelligent HUD system may turn off the indicated display information because the indicated display information is no longer relevant to the driver. For example, as discussed above, within a few seconds of receiving an incoming call, a driver may have decided whether or not to take the call. If the driver chooses to take the call, the information about the call is no longer relevant. If the driver chooses not to take the call, the driver may, within a few seconds, make a mental note of the caller. The driver may also access a call log at a later time to determine who called. The driver does not need persistent call information to continue driving.

In an embodiment, as an alternative seventh operation 412, the intelligent HUD system may be configured to detect a lack of a triggering event based on received sensor information and data. For example, as discussed in more detail above, the intelligent HUD system may determine that a driver is no longer exceeding a speed limit. In such a scenario, displayed information relevant to the triggering event may no longer be relevant to a driver if the triggering event has passed or a triggering condition is no longer occurring. Therefore, as an eighth operation 414, the intelligent HUD system may turn off the display of indicated information.

The example method as shown in FIG. 4 may be implemented using an intelligent HUD activation system as shown in FIG. 2. For example, receiving vehicle sensor information 404 may be accomplished by receiving information from vehicle sensors 152. Vehicle sensors 152 may include, for example, vehicle speed 214. Sensors 152 may also include, for example, environmental sensors 228. Environmental sensors 228 could include temperature sensors to sense the temperature external to the vehicle. As another example, receiving vehicle and environmental data 406 may be accomplished using vehicle systems 158. Vehicle systems 158 may include, for example, a GPS and/or vehicle positioning system 272 which may collect and communicate information regarding a vehicle's geographical location.

An intelligent HUD detection/activation circuit 210 may determine whether the received sensor data and environmental data constitute a triggering event. The detection/activation circuit 210 may compare sensor data and environmental data to stored data indicating a triggering event. The detection/activation circuit 210 may also leverage artificial intelligent and/or machine learning techniques to determine whether a set of received sensor data and/or environmental data constitute a triggering event. Once the detect/activation circuit 210 determines that a triggering event is occurring, the circuit 210 may provide instructions indicating that information relevant to the triggering event be displayed on the HUD. The HUD may be a vehicle system 158 in communication with the sensors 152 and/or circuit 210. The circuit 210 may, via communication with vehicle systems 158, including a HUD system, display information relevant to a triggering event on the HUD, display information relevant to a triggering event on the HUD for a set period of time or until the triggering event is no longer detected, and may turn off display information as may be appropriate.

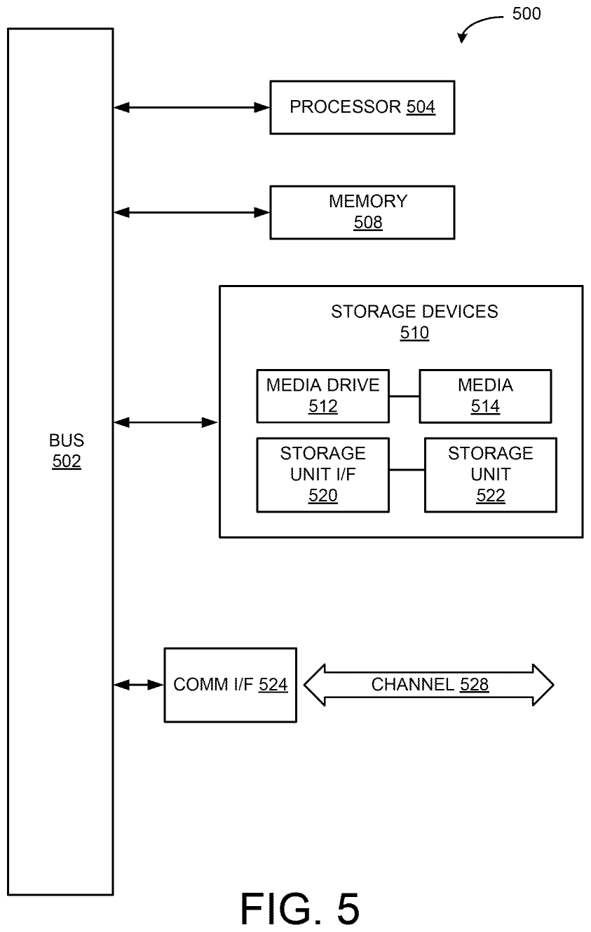

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. This can include a processor, and/or any one or more of the components making up a user device, a user system, and a non-decrypting cloud service. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. An intelligent heads up display (“HUD”) system comprising:
a HUD;
vehicle sensors and systems; and
an intelligent HUD circuit wherein the circuit:
receives vehicle sensor and system data;
determines whether the sensor and system data indicate a triggering event; and
based on its determination that the sensor and system data indicate a triggering event, instructs the HUD to selectively display intelligently enabled display information relevant to the triggering event, wherein the triggering event comprises an informational change.

2. The system of claim 1 wherein the triggering event further comprises vehicle operation contrary to law.

3. The system of claim 1 wherein the triggering event further comprises a dangerous driving condition.

4. The system of claim 1 wherein the triggering event further comprises detection of a dangerous weather condition.

5. The system of claim 1 wherein the triggering event further comprises a composite event based on both detection of a dangerous weather condition and detection of a nearby road condition rendered more dangerous by the dangerous weather condition.

6. The system of claim 5 wherein the dangerous weather condition comprises an icy condition and the nearby road condition rendered more dangerous by the icy condition comprises a bridge over which the vehicle is expected to travel.

7. The system of claim 3 wherein the dangerous driving condition comprises detection of a collision risk between a vehicle equipped with the intelligent HUD system and a preceding obstacle.

8. (canceled)

9. The system of claim 1 wherein the informational change comprises a change in navigation instructions.

10. The system of claim 1 wherein the informational change comprises an incoming call.

11. The system of claim 1 wherein the informational change comprises a change in a music track played by a vehicle equipped with the intelligent HUD system.

12. The system of claim 1 wherein the informational change comprises activation of an anti-lock braking system (“ABS”).

13. The system of claim 1 wherein the intelligent HUD circuit instructs the HUD to display the current vehicle speed.

14. An intelligent heads up display (“HUD”) system comprising:
a HUD;
vehicle sensors and systems; and
an intelligent HUD circuit wherein the circuit:
receives vehicle sensor and system data;
determines whether the sensor and system data indicate a triggering event; and
based on its determination that the sensor and system data indicate a triggering event, instructs the HUD to selectively display intelligently enabled display information relevant to the triggering event, wherein the intelligently enabled display information comprises a speed limit set for an area in which the driver is operating the vehicle.

15. An intelligent heads up display (“HUD”) system comprising:
a HUD;
vehicle sensors and systems; and
an intelligent HUD circuit wherein the circuit:
receives vehicle sensor and system data;
determines whether the sensor and system data indicate a triggering event, wherein the triggering event comprises detection of a driver operating a vehicle at a speed exceeding a speed limit set for an area in which the driver is operating the vehicle; and
based on its determination that the sensor and system data indicate a triggering event, instructs the HUD to selectively display intelligently enabled display information relevant to the triggering event.

16. An intelligent heads up display (“HUD”) system comprising:
a HUD;
vehicle sensors and systems; and
an intelligent HUD circuit wherein the circuit:
receives vehicle sensor and system data;
determines whether the sensor and system data indicate a triggering event;
based on its determination that the sensor and system data indicate a triggering event, instructs the HUD to selectively display intelligently enabled display information relevant to the triggering event;
receives updated vehicle sensor and system data;
determines whether the updated sensor and system data indicate a triggering event; and
based on its determination that the updated sensor and system data no longer indicate a triggering event, instructs the HUD to turn off intelligently enabled display information relevant to the triggering event.

17. The system of claim 16 wherein the intelligent HUD circuit instructs the HUD to selectively turn off intelligently enabled display information relevant to the no longer detected triggering event, without turning off the entire display.

18. An intelligent heads up display (“HUD”) system comprising:
a HUD;
vehicle sensors and systems; and
an intelligent HUD circuit wherein the circuit:
receives vehicle sensor and system data;
determines whether the sensor and system data indicate a triggering event;
based on its determination that the sensor and system data indicate a triggering event, instructs the HUD to selectively display intelligently enabled display information relevant to the triggering event;
instructs the HUD to continue to selectively display the intelligently enabled display information for a set period of time following the triggering event; and
instructs the HUD to selectively turn off the display of the intelligently enabled display information after the set period of time elapses.

19. A customizable intelligent heads up display (“HUD”) system comprising:
a HUD;
vehicle sensors and systems;
a user interface for a user to customize intelligently enabled display information for display on the HUD based on customized triggering events; and
an intelligent HUD circuit wherein the circuit:
receives a user indication of intelligently enabled display information based on customized triggering events from the user interface;
receives a user indication of a customized period of time during which the user would like the HUD to display the intelligently enabled display information indicated by the user;
receives vehicle sensor and system data;
determines whether the sensor and system data indicate a customized triggering event;
based on its determination that the sensor and system data indicate a customized triggering event, instructs the HUD to selectively display the user indicated intelligently enabled display information relevant to the customized triggering event;
instructs the HUD to continue to display the user indicated intelligently enabled display information for the customized period of time set by the user; and
instructs the HUD to turn off the user indicated intelligently enabled display information after the customized period of time set by the user expires.

20. (canceled)

21. The system of claim 14 wherein the triggering event comprises a dangerous driving condition.

22. The system of claim 14 wherein the intelligently enabled display information further comprises the current vehicle speed.

23. The system of claim 15 wherein the intelligently enabled display information comprises the current vehicle speed.

24. The system of claim 16 wherein the triggering event comprises detection of a dangerous weather condition.

25. The system of claim 18 wherein the triggering event comprises detection of a dangerous weather condition.

26. The system of claim 18 wherein the intelligently enabled display information comprises the current vehicle speed.

27. The system of claim 19 wherein the customized triggering events comprise a dangerous driving condition.

28. The system of claim 19 wherein the customized triggering events comprise detection of a dangerous weather condition.

29. The system of claim 19 wherein the customized triggering events comprise an informational change.

30. The system of claim 19 wherein the user indicated intelligently enabled display information comprises the current vehicle speed.

31. The system of claim 19 wherein the user indicated intelligently enabled display information comprises a speed limit set for an area in which the driver is operating the vehicle.

32. The system of claim 19 wherein the customized triggering events comprise detection of a driver operating a vehicle at a speed exceeding a speed limit set for an area in which the driver is operating the vehicle.
